(19) United States
(12) Patent Application Publication
(10) Pub. No.: US 2026/0320807 A1
(43) Pub. Date: Oct. 15, 2026

(54) NOTIFICATION SYSTEM, CONTROL METHOD, METHOD FOR MANUFACTURING ARTICLE, AND RECORDING MEDIUM

(71) Applicant: CANON KABUSHIKI KAISHA, Tokyo (JP)

(72) Inventor: HIRONOBU SASAKI, Kanagawa (JP)

(21) Appl. No.: 19/577,803

(22) Filed: Mar. 25, 2026

(30) Foreign Application Priority Data
Apr. 15, 2025 (JP) 2025-067011

(51) Int. Cl. G06T 7/246; G05D 1/243

(52) U.S. Cl. CPC G06T 7/246; G05D 1/2437

(57) ABSTRACT

A system includes a wearable device configured to notify information to a user, and a control device. The control device is configured to cause the wearable device to notify notification information related to a movement route of a moving body.

### BACKGROUND

### Field of the Technology

The present disclosure relates to a notification system, a wearable device, a control method, a method for manufacturing an article, and a recording medium.

### Description of the Related Art

In a production site, a moving body such as an automatically movable transport vehicle is used. A worker at the production site needs to carefully perform work not to collide with the moving body. JP 2022-122936 A discloses a method for displaying information on a transport vehicle on a head-mounted display.

When the worker enters a movement route of the moving body, the moving body needs to perform an operation of avoiding collision with the worker, for example, an operation of decelerating to a stop. When such an operation occurs in the moving body, there is a risk that productivity may decrease. For this reason, measures are taken such as installing a tape indicating the movement route of the moving body on the floor so that the movement route of the moving body can be seen, but it is necessary to replace the tape every time the movement route of the moving body changes, which requires time and effort for the replacement work and increases the cost. Therefore, there has been a demand for improvement.

### SUMMARY

The present disclosure provides a technology advantageous for improving productivity.

According to a first aspect of the present disclosure, a system includes a wearable device configured to notify information to a user of the wearable device, and a control device. The control device is configured to cause the wearable device to notify notification information related to a movement route of a moving body.

According to a second aspect of the present disclosure, a wearable device configured to notify information to a user of the wearable device, the wearable device includes a controller. The controller is configured to cause the wearable device to notify notification information related to a movement route of a moving body.

According to a third aspect of the present disclosure, a control method for controlling a wearable device configured to notify information to a user of the wearable device includes causing the wearable device to notify notification information related to a movement route of a moving body.

Features of the present disclosure will become apparent from the following description of embodiments with reference to the attached drawings. The following description of embodiments is described by way of example.

### BRIEF DESCRIPTION OF THE DRAWINGS

FIG. 1 is an explanatory diagram of a notification system according to the first embodiment.

FIG. 2 is a block diagram illustrating a configuration of the notification system according to the first embodiment.

FIG. 3A is a flowchart according to the first embodiment.

FIG. 3B is a flowchart according to the first embodiment.

FIG. 4A is an explanatory diagram illustrating an example of an environment in which a wearable device according to the first embodiment is used.

FIG. 4B is an explanatory diagram illustrating an example of an image notified to a user by the wearable device according to the first embodiment.

FIG. 5A is an explanatory diagram illustrating an example of an environment in which a wearable device according to the second embodiment is used.

FIG. 5B is an explanatory diagram illustrating an example of an image notified to a user by the wearable device according to the second embodiment.

FIG. 6A is an explanatory diagram illustrating an example of an environment in which a wearable device according to the third embodiment is used.

FIG. 6B is an explanatory diagram illustrating an example of an image notified to a user by the wearable device according to the third embodiment.

FIG. 6C is an explanatory diagram illustrating an example of an image notified to a user by the wearable device according to the third embodiment.

FIG. 7A is an explanatory diagram illustrating an example of an environment in which a wearable device according to the fourth embodiment is used.

FIG. 7B is an explanatory diagram illustrating an example of an image notified to a user by the wearable device according to the fourth embodiment.

FIG. 8A is an explanatory diagram illustrating an example of an environment in which a wearable device according to the fifth embodiment is used.

FIG. 8B is an explanatory diagram illustrating an example of an image notified to a user by the wearable device according to the fifth embodiment.

FIG. 9A is an explanatory diagram illustrating an example of an environment in which a wearable device according to the sixth embodiment is used.

FIG. 9B is an explanatory diagram illustrating an example of an image notified to a user by the wearable device according to the sixth embodiment.

FIG. 10A is an explanatory diagram illustrating an example of an environment in which a wearable device according to the seventh embodiment is used.

FIG. 10B is an explanatory diagram illustrating an example of an image notified to a user by the wearable device according to the seventh embodiment.

FIG. 11A is an explanatory diagram illustrating an example of an environment in which a wearable device according to the eighth embodiment is used.

FIG. 11B is an explanatory diagram illustrating an example of an image notified to a user by the wearable device according to the eighth embodiment.

FIG. 12A is an explanatory diagram illustrating an example of an image notified to a user by a wearable device according to the ninth embodiment.

FIG. 12B is an explanatory diagram illustrating an example of an image notified to a user by a wearable device according to the first modification of the ninth embodiment.

FIG. 12C is an explanatory diagram illustrating an example of an image notified to a user by a wearable device according to the second modification of the ninth embodiment.

FIG. 13A is an explanatory diagram illustrating an example of an environment in which a wearable device according to the tenth embodiment is used.

FIG. 13B is an explanatory diagram illustrating an example of an image notified to a user by the wearable device according to the tenth embodiment.

FIG. 14A is an explanatory diagram illustrating an example of an environment in which a wearable device according to the eleventh embodiment is used.

FIG. 14B is an explanatory diagram illustrating an example of an image notified to a user by the wearable device according to the eleventh embodiment.

FIG. 14C is an explanatory diagram illustrating another example of an image notified to a user by the wearable device according to the eleventh embodiment.

### DESCRIPTION OF THE EMBODIMENTS

Hereinafter, embodiments of the present disclosure will be described in detail with reference to the drawings. Configurations of the following embodiments, for example, detailed configurations, can be appropriately modified for implementation by those skilled in the art without departing from the gist of the present disclosure. In addition, it should be noted that, in the drawings referred to in the following description of embodiments, elements denoted by the same reference signs have the same functions unless otherwise specified. In addition, since these drawings are schematically represented for convenience of illustration and description, shapes, sizes, arrangements, and the like are not exactly consistent among the drawings.

### First Embodiment

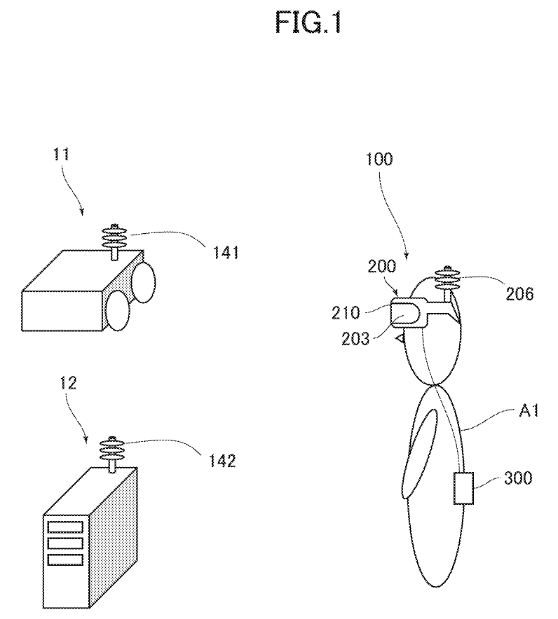

FIG. 1 is an explanatory diagram of a notification system 100 according to the first embodiment. The notification system 100 includes a wearable device 200 that can be worn by a user A1 and a control device 300. The wearable device 200 is configured to be capable of notifying the user A1 of notification information such as images, vibrations, or sounds, and is used by the user A1 in an environment such as a production site. The user A1 who uses the wearable device 200 is a worker at a production site or the like. The user A1 can wear the wearable device 200 and perform some work at the production site. The wearable device 200 is, for example, a head-mounted display, and can be worn on the head of the user A1. Note that “notification” means that the notification system 100 causes the user A1 to grasp the notification information by various means such as display, sound, vibration, and other methods.

At the production site (e.g., a factory), a transport vehicle 11, which is an example of a moving body that can automatically move, and a server 12 that holds information about the transport vehicle 11 are arranged. The transport vehicle 11 is capable of moving autonomously without relying on an operation by the user A1. At the production site, a production system is configured including the transport vehicle 11 and the server 12. The transport vehicle 11 is a monitoring target of the user A1. The transport vehicle 11 is used to manufacture an article. The transport vehicle 11 is used, for example, to transport parts that will become some portions of the article at the production site, and is controlled to move along a predetermined movement route (travel route). The article manufactured using the transport vehicle 11 may be a finished product (final product) or an intermediate product.

When detecting that there is an obstacle (including a person) on the movement route in its movement direction, the transport vehicle 11 performs an avoidance operation to avoid a collision with the obstacle. The avoidance operation of the transport vehicle 11 is, for example, an operation of decelerating to a stop, an operation of traveling to bypass the obstacle, or the like.

The transport vehicle 11 includes a communication device 141, and is configured to be capable of wirelessly communicating with the server 12 via the communication device 141. The server 12 is constituted by a computer including a processor such as a CPU. The server 12 includes a communication device 142, and is configured to be capable of wirelessly communicating with the transport vehicle 11 and the notification system 100. The server 12 can acquire various types of information such as a moving speed and a current position of the transport vehicle 11 from the transport vehicle 11 in real time via the communication device 142.

The wearable device 200 includes a wearable tool 210 that can be worn by the user A1 and a display device 203 provided on the wearable tool 210. The wearable tool 210 is, for example, a frame having a shape similar to that of an eyeglass frame. The wearable device 200 can display various types of information in the field of view of the user A1. The wearable device 200 may be of either a binocular type covering both eyes of the user A1 or a monocular type covering only one eye of the user A1.

The control device 300 is configured to be capable of communicating with the wearable device 200 in a wired or wireless manner. The control device 300 is portable to the user A1. In the example of FIG. 1, the control device 300 is configured separately from the wearable device 200, but may be configured integrally with the wearable device 200. The control device 300 is controller for the wearable device 200. The control device 300 may be built-in a casing (cabinet, housing) of the wearable device 200.

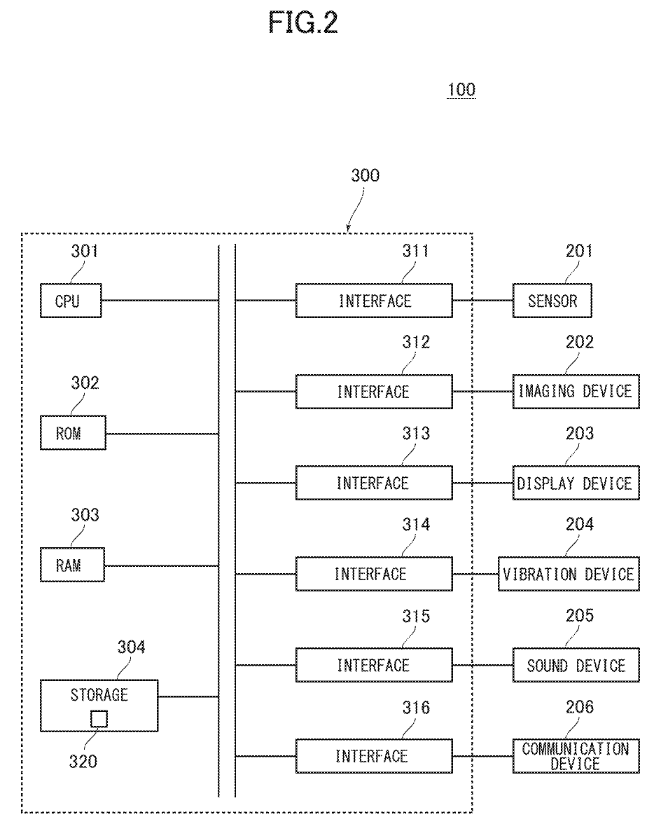

FIG. 2 is a block diagram illustrating a configuration of the notification system 100 according to the first embodiment. The control device 300 is an example of an information processing device, and is constituted by a computer. The control device 300 includes a central processing unit (CPU) 301 serving as a processor. In addition, the control device 300 includes storage devices such as a read only memory (ROM) 302, a random access memory (RAM) 303, and a storage 304 as examples of storage units.

The control device 300 includes a plurality of interfaces 311 to 316. The ROM 302, the RAM 303, the storage 304, and the interfaces 311 to 316 are connected to the CPU 301 via a bus.

The ROM 302 stores a basic program read by the CPU 301 when the computer is started. The RAM 303 is a storage device that temporarily stores various types of data such as arithmetic processing results of the CPU 301. The storage 304 is a storage device that stores arithmetic processing results of the CPU 301, various types of data acquired from the outside, and the like. The storage 304 is constituted by, for example, an SSD or an HDD. A program 320 for causing the CPU 301 to execute arithmetic processing and control processing is recorded (stored) in the storage 304. The CPU 301 executes a control method such as control processing and information processing of the wearable device 200 based on the program 320 recorded (stored) in the storage 304. The interfaces 311 to 316 are interfaces that input and output data.

The wearable device 200 includes a sensor 201, an imaging device 202, a display device 203, which is an example of a notification unit, a vibration device 204, which is an example of a notification unit, a sound device 205, which is an example of a notification unit, and a communication device 206 for communicating with the server 12.

The sensor 201 is connected to the interface 311, and sends information indicating a sensing result to the CPU 301 via the interface 311. The sensor 201 is a sensor used to measure a position of the user A1 (that is, the wearable device 200) and a direction in which the face of the user A1 (that is, the wearable device 200) is oriented. The sensor 201 is disposed in, for example, the wearable tool 210. The sensor used to measure the position of the user A1 is, for example, an indoor GPS receiver. The sensor used to measure the direction in which the face of the user A1 is oriented is, for example, an acceleration sensor, a gyro sensor, or a geomagnetic sensor. Here, the position of the user A1 is also a position of the wearable device 200 (that is, the wearable tool 210). Furthermore, the direction of the user A1 is a direction in which the face of the user A1 is oriented, in other words, a line-of-sight direction of the user A1. Furthermore, the direction of the user A1 is also a direction of the wearable device 200 (that is, the wearable tool 210).

The imaging device 202 is used to recognize an object in the direction in which the face of the user A1 (that is, the wearable device 200) is oriented. The imaging device 202 is connected to the interface 312, and sends an image (data) generated by imaging to the CPU 301 via the interface 312. The imaging device 202 is a digital camera having an image sensor such as a CCD image sensor or a CMOS image sensor. The imaging device 202 is disposed on the wearable tool 210. The imaging device 202 is disposed at a position to capture an image in the same direction as the direction in which the face of the user A1 is oriented. That is, the imaging device 202 captures an image of a scene that is substantially the same as the scene that the user A1 is viewing. The imaging device 202 can capture an image in the same direction as the line-of-sight direction of the user A1.

The display device 203 is connected to the interface 313, and is configured to display an image under the control of the CPU 301 via the interface 313. The display device 203 is disposed on the wearable tool 210. The display device 203 is disposed at a position overlapping the field of view of the user A1, that is, at a position corresponding to a lens of a glass in the wearable tool 210, in a state where the user A1 wears the wearable device 200. The display device 203 is constituted by, for example, a transmissive display. In this case, the user A1 can view an actual scene through the display device 203 so as to be superimposed on an image displayed on the display device 203 without the field of view of the user A1 being obstructed by the display device 203. The scene viewed from the user A1 who is a worker is a scene in a factory. Depending on the position and the direction of the user A1 in the factory, the transport vehicle 11 moving in the factory may appear in the field of view of the user A1, or the transport vehicle 11 may disappear from the field of view of the user A1.

Note that the display device 203 is not limited to the transmissive display, and may be, for example, a non-transmissive display. In this case, the display device 203 can display a scene image obtained by capturing a scene with the imaging device 202 on the display device 203 in real time. Furthermore, the display device 203 is not limited to a display that displays an image on itself, and for example, the display device 203 may be configured to project an image onto the retina of the user A1.

The vibration device 204 is connected to the interface 314, and is configured to vibrate under the control of the CPU 301 via the interface 314. The sound device 205 is connected to the interface 315, and is configured to output a sound such as a buzzer sound or a voice via the interface 315. The vibration device 204 and the sound device 205 are arranged in, for example, the wearable tool 210.

The communication device 206 is connected to the interface 316, and is configured to be capable of wirelessly communicating with a communication counterpart such as the server 12 under the control of the CPU 301. The communication device 206 is disposed in, for example, the wearable tool 210.

The storage 304 is also a non-transitory computer-readable recording medium. In the present embodiment, the program 320 is stored in the storage 304, but the storage of the program 320 is not limited thereto. The program 320 may be recorded in any recording medium as long as the recording medium is a non-transitory computer-readable recording medium. For example, a flexible disk, a hard disk, an optical disk, a magneto-optical disk, a magnetic tape, or a non-volatile memory can be used as a recording medium for supplying the program 320 to the computer. The optical disk is, for example, a disk medium such as a Blu-ray disk, a DVD, or a CD. The non-volatile memory is, for example, a storage device such as a USB memory, a memory card, a ROM, or an SSD.

Furthermore, the control device 300 may be configured to be capable of communicating with an external device via a network, and the program 320 may be downloaded from the external device via the network.

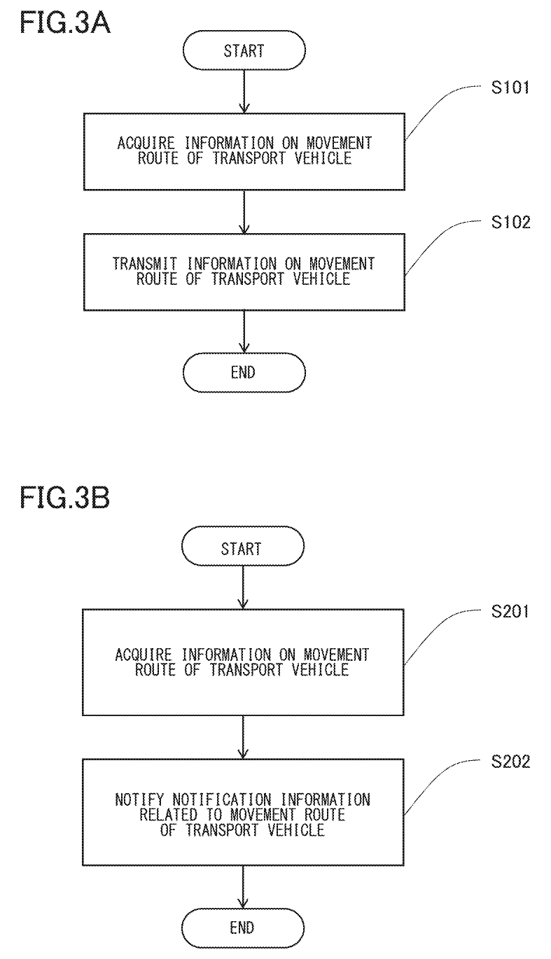

FIGS. 3A and 3B are flowcharts according to the first embodiment. FIG. 3A is a flowchart of processing of the server 12, and FIG. 3B is a flowchart of processing of the notification system 100.

The server 12 acquires information on a movement route of the transport vehicle 11 (S101). The information on the movement route of the transport vehicle 11 may be calculated by the transport vehicle 11, may be calculated by the server 12, or may be input by a person, but the latest information on the movement route is acquired by the server 12. Next, the server 12 transmits the information on the movement route of the transport vehicle 11 to the notification system 100 (S102).

The control device 300 of the notification system 100 acquires the information on the movement route of the transport vehicle 11 from the server 12 via the communication device 206 (S201). Then, the control device 300 of the notification system 100 causes the wearable device 200 to notify notification information (image, vibration, or sound) related to the movement route of the transport vehicle 11 (S202).

As described above, since the notification information related to the movement route of the transport vehicle 11 is notified to the user A1, there is no need to attach an adhesive tape indicating the movement route of the transport vehicle 11 onto the floor. Then, the user A1 can grasp the movement route of the transport vehicle 11 in real time through the notification system 100, and can efficiently avoid the transport vehicle 11 without disturbing the travel of the transport vehicle 11. As a result, the work efficiency at the production site is improved, and the productivity of articles is improved.

The notification information related to the movement route of the transport vehicle 11 notified to the user A1 may be a vibration by the vibration device 204 or a sound (e.g., announcement sound) by the sound device 205, but may be an image indicating the movement route of the transport vehicle 11 displayed on the display device 203. Hereinafter, a case where the notification information notified to the user A1 is an image will be described as an example.

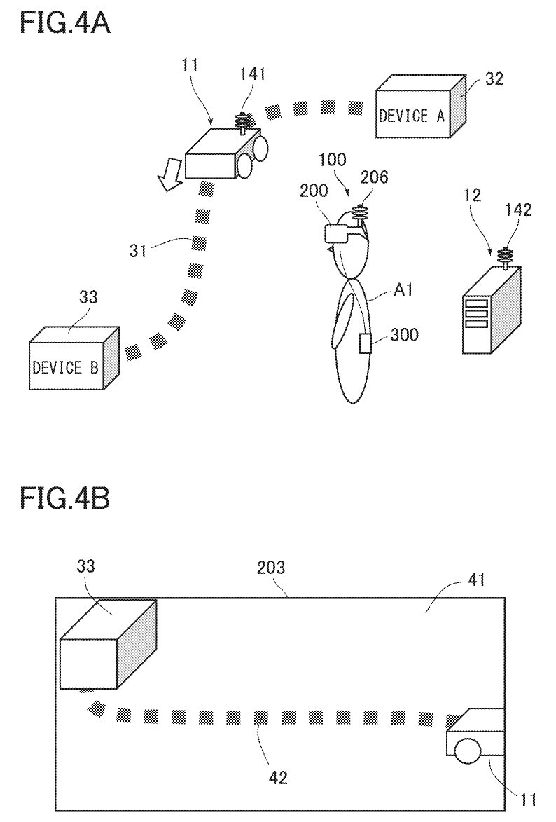

FIG. 4A is an explanatory diagram illustrating an example of an environment in which the wearable device 200 according to the first embodiment is used. In the example of the environment illustrated in FIG. 4A, the transport vehicle 11 is moving along a movement route 31 from a device A 32 to a device B 33. In FIG. 4A, the movement route 31 is indicated by a broken line for convenience of description, but the movement route 31 is not illustrated in an actual environment. That is, the movement route 31 does not need to be indicated by a tape or the like. The information on the movement route 31 of the transport vehicle 11 is held in the server 12, and the control device 300 receives the information on the movement route 31 of the transport vehicle 11 from the server 12 via the communication device 206.

FIG. 4B is an explanatory diagram illustrating an example of an image notified to the user A1 by the wearable device 200 according to the first embodiment. In a field of view 41 of the user A1 wearing the wearable device 200, the transport vehicle 11 and the device B 33 existing in the environment are present, and the user A1 can view a scene including the transport vehicle 11 and the device B 33 through the display device 203. Then, the display device 203 of the wearable device 200 displays an image 42 indicating the movement route 31 of the transport vehicle 11 so as to be superimposed on the scene in the field of view 41 of the user A1. The image 42 illustrated in FIG. 4B is an image of a line (e.g., a broken line) along the actual movement route 31.

As described above, the control device 300 causes the display device 203 of the wearable device 200 to notify the image 42 indicating the movement route 31 of the transport vehicle 11 so as to be superimposed on the scene viewed from the user A1. As a result, the user A1 can grasp the movement route 31 of the transport vehicle 11 in real time, and can efficiently avoid the transport vehicle 11.

Here, causing the wearable device 200 to notify the image 42 indicating the movement route 31 of the transport vehicle 11 means causing the display device 203 of the wearable device 200 to display the image 42 indicating the movement route 31 of the transport vehicle 11.

Note that, in a case where the display device 203 is a non-transmissive display, a scene image obtained by imaging a scene using the imaging device 202 and an image 42 superimposed on the scene image are displayed on the display device 203.

Here, in the first embodiment, in step S201, the control device 300 acquires information on a position and a direction of the user A1. The information on the position and the direction of the user A1 is acquired, for example, based on a sensing result of the sensor 201 or an image captured by the imaging device 202.

The control device 300 receives the information on the movement route 31 of the transport vehicle 11 from the server 12, and obtains the image 42 as notification information related to the movement route 31 of the transport vehicle 11 using the information on the movement route 31 of the transport vehicle 11 and the information on the position and the direction of the user A1. As a result, the image 42 is acquired as the notification information.

The image 42 is an image indicating the movement route 31 of the transport vehicle 11 viewed from the user A1. In this manner, the control device 300 calculates a position and a direction of the user A1 wearing the wearable device 200, and obtains an image 42 such that the position and the direction match the scene viewed from the user A1. As a result, the image 42 indicating the movement route 31 can be displayed on the display device 203 so as to be superimposed on the scene. That is, since the image 42 is obtained so as to follow the actual movement route 31, the user A1 can more intuitively grasp the actual movement route 31 by viewing the image 42 superimposed on the scene.

Note that the case where the image 42 is obtained by the control device 300 has been described as an example, but the acquisition of the image 42 is not limited thereto, and the image 42 may be obtained by the server 12. In this case, the control device 300 may transmit the information on the position and the direction of the user A1 to the server 12, request the server 12 for the notification information, and cause the server 12 to obtain the image 42 according to the information on the position and the direction of the user A1 as the notification information. Then, the control device 300 may receive the image 42 obtained by the server 12 from the server 12. As a result, the requested image 42 is acquired as the notification information.

### Second Embodiment

The second embodiment will be described. Hereinafter, elements denoted by the same reference signs as those in the above-described embodiment have substantially the same configurations and functions as those described in the above-described embodiment unless otherwise specified, and differences from the above-described embodiment will be mainly described.

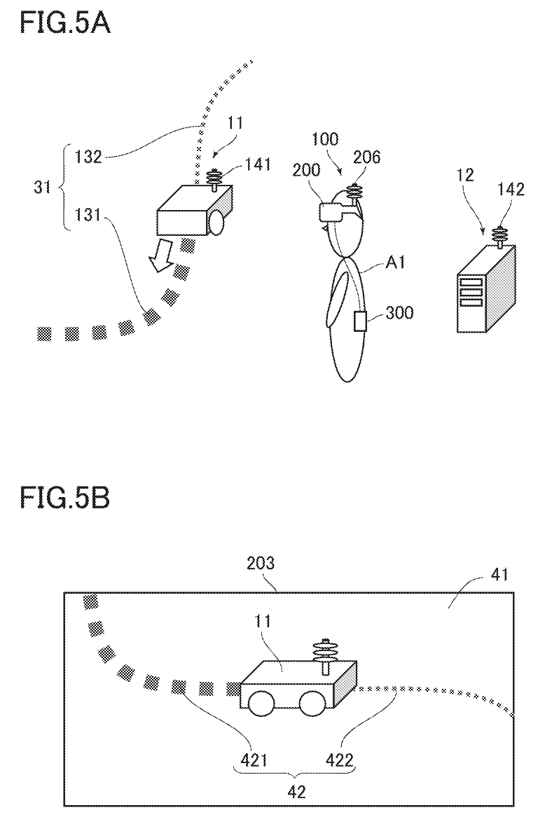

FIG. 5A is an explanatory diagram illustrating an example of an environment in which a wearable device 200 according to the second embodiment is used. FIG. 5B is an explanatory diagram illustrating an example of an image notified to a user A1 by the wearable device 200 according to the second embodiment. Note that a configuration of a notification system 100 is the same as that described in the first embodiment, and the description thereof will be omitted.

It is assumed that a transport vehicle 11 existing in the environment is in a field of view 41 of the user A1 wearing the wearable device 200. A movement route 31 of the transport vehicle 11 includes a first route 131 along which the transport vehicle 11 has not moved and a second route 132 along which the transport vehicle 11 has moved.

For example, in the environment, there is a movement route 31 corresponding to the transport vehicle 11, the transport vehicle 11 is moving in a direction indicated by an arrow illustrated in FIG. 5A, and there are a first route 131 in the movement direction of the transport vehicle 11 and a second route 132 along which the transport vehicle 11 has already traveled. From the transport vehicle 11, information on a position and a movement direction of the transport vehicle 11 is transmitted to a server 12.

A control device 300 causes the server 12 to perform a movement route acquisition process for acquiring a movement route of the transport vehicle 11, using the information on the position and the line-of-sight direction of the user A1 (the wearable device 200) as arguments. The server 12 calculates the movement route 31 of the transport vehicle 11 from the information on the position and the line-of-sight direction of the user A1 wearing the wearable device 200 and the information on the position and the movement direction of the transport vehicle 11. At this time, the information on the first route 131 in the movement direction of the transport vehicle 11 and the information on the second route 132 that has already been traveled are returned distinguishably. A display device 203 of the wearable device 200 displays an image 42 indicating the movement route 31 so as to be superimposed on the scene. Here, the first route 131 is useful for the user A1. Therefore, an image 421 indicating the first route 131 and an image 422 indicating the second route 132 can be displayed on the display device 203 in mutually different display forms.

That is, in the second embodiment, when the movement route 31 is present in the field of view 41 of the user A1 wearing the wearable device 200, the control device 300 causes the display device 203 of the wearable device 200 to display the image 42 (the image 421 and the image 422) in such a manner that the display form of the image 421 indicating the first route 131 is different from the display form of the image 422 indicating the second route 132 in the image 42 indicating the movement route 31.

For example, a color change, a thickness, or a blinking degree of a line that is the image 421 indicating the first route 131 to be emphasized may be made different from that of the image 422 indicating the second route 132, or conversely, a transmittance of a line that is the image 422 indicating the second route 132 may be made different from that of a line that is the image 421 indicating the first route 131, or a line that is the image 422 indicating the second route 132 may be made different from that of a line that is the image 421 indicating the first route 131 by displaying a dotted line or the like. As described above, the image 421 indicating the first route 131, which is useful information for the user A1, is displayed in an emphasized form, thereby making it possible to prevent the display from being cluttered.

In addition, the image 421 indicating the first route 131 in the movement route 31 of the transport vehicle 11 is displayed on the display device 203 of the wearable device 200 so as to be superimposed on the scene, so that the user A1 can grasp the first route 131 in the movement route 31 of the transport vehicle 11 in real time, and can efficiently avoid the transport vehicle 11.

In the second embodiment, the case where the image 422 indicating the second route 132 that has already been traveled is also displayed on the display device 203 has been described, but the display of the image is not limited thereto. That is, the control device 300 may cause the display device 203 of the wearable device 200 to display only the image 421 indicating the first route 131, without displaying the second route 132, as the image 42 indicating the movement route 31. In this manner, by adopting a method in which only the image 421 indicating the first route 131 to be emphasized is only displayed, the communication load between the server 12 and the communication device 206 can be reduced.

### Third Embodiment

The third embodiment will be described. Hereinafter, elements denoted by the same reference signs as those in the above-described embodiment have substantially the same configurations and functions as those described in the above-described embodiment unless otherwise specified, and differences from the above-described embodiment will be mainly described.

In a case where there are a plurality of moving bodies in an environment such as a production site, there are a plurality of movement routes corresponding to the plurality of moving bodies, respectively. In addition, in an environment such as a production site, a plurality of workers are engaged in work. Each of the plurality of workers carries one of a plurality of notification systems. In this case, simultaneously transmitting information on all movement routes to each of the plurality of notification systems leads to an increase in communication load. Therefore, in the third embodiment, each of the plurality of notification systems is configured to acquire only information on the movement route of the corresponding moving body among the plurality of moving bodies.

Hereinafter, a case where the plurality of moving bodies are two transport vehicles, the plurality of users are two users, and the plurality of notification systems are two notification systems will be described as an example. Note that the number of moving bodies is not limited to two. In addition, the number of users is not limited to two, and the number of notification systems is also not limited to two.

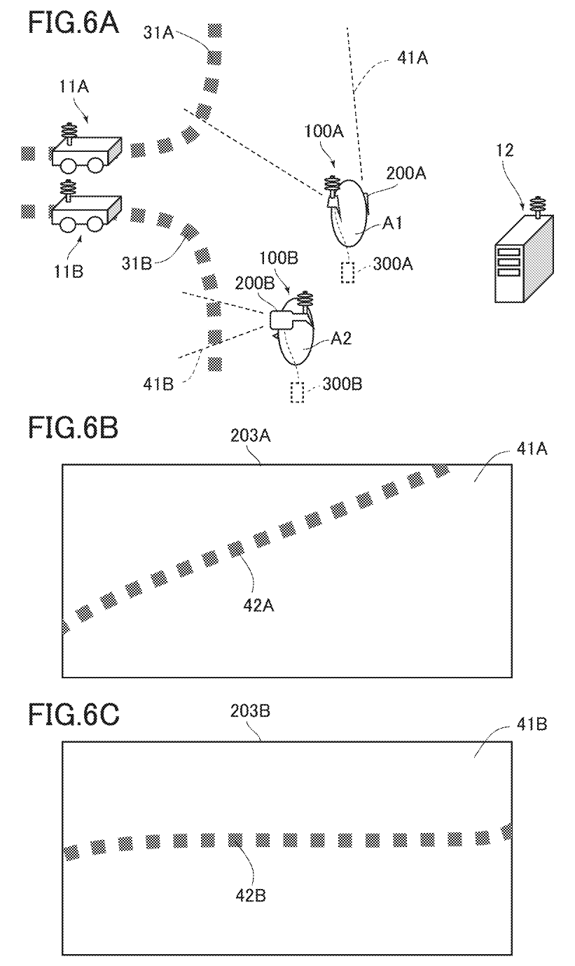

FIG. 6A is an explanatory diagram illustrating an example of an environment in which wearable devices 200A and 200B according to the third embodiment are used. FIG. 6B is an explanatory diagram illustrating an example of an image notified to a user A1 by the wearable device 200A according to the third embodiment. FIG. 6C is an explanatory diagram illustrating an example of an image notified to a user A2 by the wearable device 200B according to the third embodiment.

Transport vehicles 11A and 11B have the same configuration as the transport vehicle 11 described in the first embodiment, and the detailed description about the configuration of each of the transport vehicles 11A and 11B will be omitted. Notification systems 100A and 100B have the same configuration as the notification system 100 described in the first embodiment, and the detailed description about the configuration of each of the notification systems 100A and 100B will be omitted. Hereinafter, the wearable device of the notification system 100A will be referred to as wearable device 200A, and the wearable device of the notification system 100B will be referred to as wearable device 200B. Similarly, the control device of the notification system 100A will be referred to as control device 300A, and the control device of the notification system 100B will be referred to as control device 300B. In addition, the display device of the wearable device 200A will be referred to as display device 203A, and the display device of the wearable device 200B will be referred to as display device 203B. It is assumed that the wearable device 200A is worn by the user A1, and the wearable device 200B is worn by the user A2.

In the environment such as a production site illustrated in FIG. 6A, there are a movement route 31A corresponding to the transport vehicle 11A and a movement route 31B corresponding to the transport vehicle 11B. In addition, in the environment such as a production site, there are a user A1 wearing the wearable device 200A and a user A2 wearing the wearable device 200B.

The movement route 31A is present and the movement route 31B is not present in a field of view 41A of the user A1 wearing the wearable device 200A. The control device 300A causes a server 12 to perform a movement route acquisition process using the information on the position and the direction of the user A1 (the wearable device 200A) as arguments. The server 12 calculates the movement route 31A in the field of view 41A of the user A1 from the information on the position and the direction of the user A1 wearing the wearable device 200A, and returns only information on the movement route 31A in the field of view 41A of the user A1.

The control device 300A obtains an image 42A as notification information related to the movement route 31A of the transport vehicle 11A based on the acquired information on the movement route 31A and on the position and the direction of the user A1. The image 42A is displayed on the display device 203A of the wearable device 200A so as to be superimposed on the scene. In this case, the information on the movement route 31B is not transmitted to the wearable device 200A.

That is, the control device 300A acquires information on the position and the direction of the user A1, transmits the information on the position and the direction of the user A1 to the server 12, and acquires information on the movement route 31A according to the information on the position and the direction of the user A1 from the server 12. In this manner, only necessary and sufficient information is transmitted and received, thereby making it possible to prevent an increase in communication load.

Similarly, the movement route 31B is present and the movement route 31A is not present in the field of view 41B of the user A2 wearing the wearable device 200B. The control device 300B causes the server 12 to perform a movement route acquisition process using the information on the position and the direction of the user A2 (the wearable device 200B) as arguments. The server 12 calculates a movement route 31B in the field of view 41B of the user A2 from the information on the position and the direction of the user A2 wearing the wearable device 200B, and returns only information on the movement route 31B in the field of view 41B of the user A2.

The control device 300B obtains an image 42B as notification information related to the movement route 31B of the transport vehicle 11B based on the acquired information on the movement route 31B and on the position and the direction of the user A2. The image 42B is displayed on the display device 203B of the wearable device 200B so as to be superimposed on the scene. In this case, the information on the movement route 31A is not transmitted to the wearable device 200B.

That is, the control device 300B acquires information on the position and the direction of the user A2, transmits the information on the position and the direction of the user A2 to the server 12, and acquires information on the movement route 31B according to the information on the position and the direction of the user A2 from the server 12. In this manner, only necessary and sufficient information is transmitted and received, thereby making it possible to prevent an increase in communication load. In the present embodiment, the case in which only the information on the movement route in the field of view of the user is transmitted and received has been described as an example, but for example, a plurality of movement routes of a plurality of transport vehicles may be partially notified depending on the field of view of the user. As a result, it is possible to prevent an increase in communication load more than that in a case where all of the plurality of movement routes are notified to the user.

Note that the case where the image 42A is obtained by the control device 300A has been described as an example, but the acquisition of the image 42A is not limited thereto, and the image 42A may be obtained by the server 12. In this case, the control device 300A may transmit information on the position and the direction of the user A1 to the server 12, request the server 12 for notification information, and cause the server 12 to obtain the image 42A as the notification information related to the movement route 31A in the field of view 41A of the user A1. Then, the control device 300A may receive the image 42A obtained by the server 12 from the server 12. As a result, the image 42A requested as the notification information is acquired by the control device 300A. The control device 300B also performs processing similar to that of the control device 300A.

### Fourth Embodiment

The fourth embodiment will be described. Hereinafter, elements denoted by the same reference signs as those in the above-described embodiment have substantially the same configurations and functions as those described in the above-described embodiment unless otherwise specified, and differences from the above-described embodiment will be mainly described.

In a case where there are a plurality of moving bodies in an environment such as a production site, there are a plurality of movement routes corresponding to the plurality of moving bodies, respectively. Hereinafter, a case where the plurality of moving bodies are two transport vehicles will be described as an example. Note that the number of moving bodies is not limited to two.

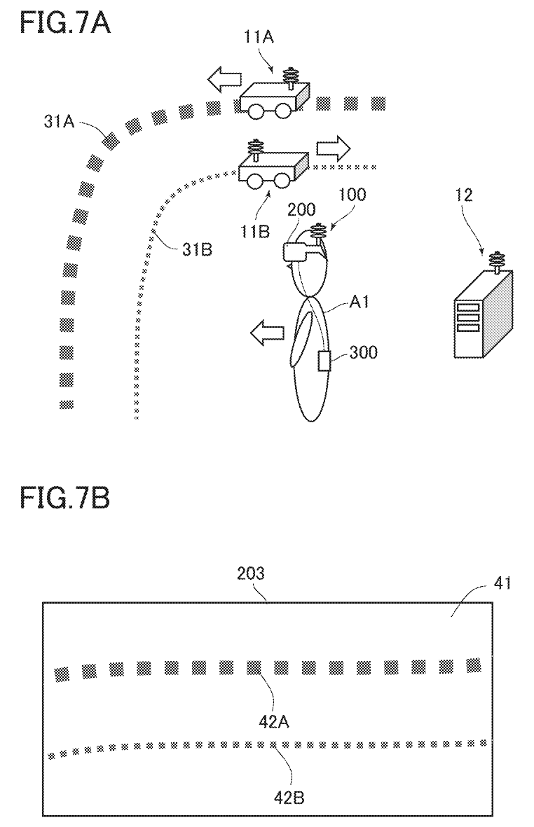

FIG. 7A is an explanatory diagram illustrating an example of an environment in which a wearable device 200 according to the fourth embodiment is used. FIG. 7B is an explanatory diagram illustrating an example of an image notified to a user A1 by the wearable device 200 according to the fourth embodiment.

In the environment such as a production site illustrated in FIG. 7A, there are a movement route 31A corresponding to a transport vehicle 11A and a movement route 31B corresponding to a transport vehicle 11B. In addition, in the environment such as a production site, there is a user A1 wearing the wearable device 200. Here, it is assumed that the user A1, the transport vehicle 11A, and the transport vehicle 11B are moving in directions indicated by respective arrows. It is assumed that the movement routes 31A and 31B are present in a field of view 41 of the user A1 wearing the wearable device 200.

Each of the transport vehicle 11A and the transport vehicle 11B transmits information on its position and movement direction to a server 12. A control device 300 causes the server 12 to perform a movement route acquisition process using the information on the position, the movement direction, and the speed of the user A1 (the wearable device 200) as arguments. The server 12 calculates a movement route 31A of the transport vehicle 11A approaching the user A1 from the information on the position, the movement direction, and the speed of the user A1 wearing the wearable device 200, and calculates a movement route 31B of the transport vehicle 11B moving away from the user A1. The server 12 returns notification information regarding these movement routes 31A and 31B. The control device 300 causes a display device 203 of the wearable device 200 to display the acquired notification information related to the movement routes 31A and 31B, that is, images 42A and 42B, so as to be superimposed on the scene. Although the case where the server 12 obtains the images 42A and 42B has been described as an example, the control device 300 may obtain the images 42A and 42B.

The user A1 is moving toward the movement route 31A of the transport vehicle 11A and the movement route 31B of the transport vehicle 11B. Among the transport vehicles 11A and 11B, the transport vehicle 11A moving in a direction approaching the user A1 is highly likely to contact the user A1. Since the transport vehicle 11B is moving in a direction away from the user A1, the likelihood of contacting the user A1 is low. Therefore, it is useful to display, in an emphasized form, the image 42A indicating the movement route 31A corresponding to the transport vehicle 11A. The method of emphasized display is similar to the method described in the second embodiment.

As described above, the control device 300 changes the display forms of the images 42A and 42B indicating movement routes displayed on the display device 203 depending on whether the transport vehicles 11A and 11B are approaching or moving away from the user A1. In the fourth embodiment, the control device 300 displays, in an emphasized form, the image 42A corresponding to the movement route 31A of the transport vehicle 11A approaching the user A1 (for example, displays the line in a bold form). In addition, in the fourth embodiment, the control device 300 displays, in a de-emphasized form, the image 42B corresponding to the movement route 31B of the transport vehicle 11B moving away from the user A1 (for example, displays the line in a thin form). That is, the control device 300 causes the display device 203 to display the images 42A and 42B in such a manner that the display form of the image 42A corresponding to the movement route 31A of the transport vehicle 11A approaching the user A1 is different from the display form of the image 42B corresponding to the movement route 31B of the transport vehicle 11B moving away from the user A1. In this manner, by displaying the movement route 31A of the transport vehicle 11A that is highly likely to collide with the user A1 in an emphasized form, the user A1 can efficiently avoid collision with the transport vehicle 11A.

In addition, since the image 42A indicating the movement route 31A of the transport vehicle 11A and the image 42B indicating the movement route 31B of the transport vehicle 11B are displayed on the display device 203 of the wearable device 200 so as to be superimposed on the scene, the user A1 can grasp the movement route 31A of the transport vehicle 11A and the movement route 31B of the transport vehicle 11B in real time, and can efficiently avoid the transport vehicle 11A and the transport vehicle 11B, particularly the transport vehicle 11A.

Note that the case where there are a plurality of movement routes of a plurality of moving bodies in the field of view 41 of the user A1 has been described as an example, but the number of movement routes in the field of view 41 of the user A1 is not limited thereto, and there may be only one movement route in the field of view 41 of the user A1. In this case as well, the control device 300 may change a display form of an image indicating a movement route displayed on the display device 203 depending on whether the moving body is approaching or moving away from the user A1.

### Fifth Embodiment

The fifth embodiment will be described. Hereinafter, elements denoted by the same reference signs as those in the above-described embodiment have substantially the same configurations and functions as those described in the above-described embodiment unless otherwise specified, and differences from the above-described embodiment will be mainly described.

In a case where there are a plurality of moving bodies in an environment such as a production site, there are a plurality of movement routes corresponding to the plurality of moving bodies, respectively. Hereinafter, a case where the plurality of moving bodies are two transport vehicles will be described as an example. Note that the number of moving bodies is not limited to two.

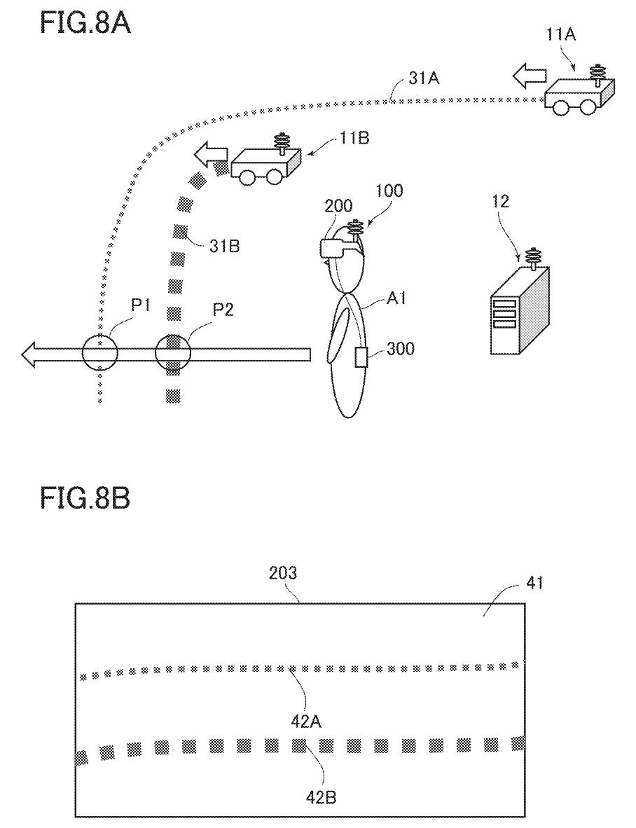

FIG. 8A is an explanatory diagram illustrating an example of an environment in which a wearable device 200 according to the fifth embodiment is used. FIG. 8B is an explanatory diagram illustrating an example of an image notified to a user A1 by the wearable device 200 according to the fifth embodiment.

In the environment such as a production site illustrated in FIG. 8A, there are a movement route 31A corresponding to a transport vehicle 11A and a movement route 31B corresponding to a transport vehicle 11B. In addition, in the environment such as a production site, there is a user A1 wearing the wearable device 200. Here, it is assumed that the user A1, the transport vehicle 11A, and the transport vehicle 11B are moving in directions indicated by respective arrows. It is assumed that the movement routes 31A and 31B are present in a field of view 41 of the user A1 wearing the wearable device 200.

Each of the transport vehicle 11A and the transport vehicle 11B transmits information on its position and movement direction to a server 12. A control device 300 causes the server 12 to perform a movement route acquisition process using the information on the position, the movement direction, and the speed of the user A1 (the wearable device 200) as arguments. The server 12 calculates movement routes of transport vehicles that are likely to contact the user A1, for example, the movement routes 31A and 31B of the transport vehicles 11A and 11B, from the information on the position, the movement direction, and the speed of the user A1 wearing the wearable device 200, and returns notification information related to the movement routes. The control device 300 causes a display device 203 of the wearable device 200 to display the acquired notification information related to the movement routes 31A and 31B, that is, images 42A and 42B, so as to be superimposed on the scene. Although the case where the server 12 obtains the images 42A and 42B has been described as an example, the control device 300 may obtain the images 42A and 42B.

In the example of FIG. 8A, the movement routes 31A and 31B of the transport vehicles 11A and 11B intersect with a movement path of the user A1. In this way, when the movement routes intersect with the movement path of the user A1, the server 12 calculates a position P1 at which the movement route 31A of the transport vehicle 11A intersects with the movement path of the user A1 and a position P2 at which the movement route 31B of the transport vehicle 11B intersects with the movement path of the user A1 from the information on the position and the movement direction of the user A1 (the wearable device 200). Next, the server 12 calculates a time until the transport vehicle 11A arrives at the position P1 and a time until the transport vehicle 11B arrives at the position P2. Then, the server 12 transmits information of the calculated times to the control device 300. Although the case where the server 12 calculates the times has been described as an example, the control device 300 may calculate the times.

The control device 300 changes the display forms of the images 42A and 42B indicating the movement routes 31A and 31B depending on the times required for the transport vehicles 11A and 11B to pass through the positions P1 and P2. In the example of the fifth embodiment, the time required for the transport vehicle 11B to pass through the position P2 is shorter than the time required for the transport vehicle 11A to pass through the position P1. The control device 300 displays, in an emphasized form, the image 42B corresponding to the movement route 31B of the transport vehicle 11B (for example, displays the line in a bold form). In addition, the control device 300 displays, in a de-emphasized form, the image 42A corresponding to the movement route 31A of the transport vehicle 11A (for example, displays the line in a thin form). That is, the control device 300 causes the display device 203 to display the images 42A and 42B in such a manner that the display form of the image 42A corresponding to the movement route 31A of the transport vehicle 11A is different from the display form of the image 42B corresponding to the movement route 31B of the transport vehicle 11B. In this manner, by displaying the movement route 31B of the transport vehicle 11B that is highly likely to collide with the user A1 in an emphasized form, the user A1 can efficiently avoid collision with the transport vehicle 11B.

In addition, since the image 42A indicating the movement route 31A of the transport vehicle 11A and the image 42B indicating the movement route 31B of the transport vehicle 11B are displayed on the display device 203 of the wearable device 200 so as to be superimposed on the scene, the user A1 can grasp the movement route 31A of the transport vehicle 11A and the movement route 31B of the transport vehicle 11B in real time, and can efficiently avoid the transport vehicle 11A and the transport vehicle 11B, particularly the transport vehicle 11B.

In addition, the control device 300 may change the display forms of the images 42A and 42B indicating the movement routes 31A and 31B depending on distances between the transport vehicles 11A and 11B and the user A1. In this case, the server 12 calculates the distances between the transport vehicles 11A and 11B and the user A1 from the information on the position of the user A1 (the wearable device 200) and the information on the positions of the transport vehicles 11A and 11B. The information on the distances is transmitted to the control device 300. Although the case where the server 12 calculates the distances has been described as an example, the control device 300 may calculate the distances.

In the example of the fifth embodiment, the distance between the transport vehicle 11B and the user A1 is shorter than the distance between the transport vehicle 11A and the user A1. The control device 300 displays, in an emphasized form, the image 42B corresponding to the movement route 31B of the transport vehicle 11B (for example, displays the line in a bold form). In addition, the control device 300 displays, in a de-emphasized form, the image 42A corresponding to the movement route 31A of the transport vehicle 11A (for example, displays the line in a thin form). That is, the control device 300 causes the display device 203 to display the images 42A and 42B in such a manner that the display form of the image 42A corresponding to the movement route 31A of the transport vehicle 11A is different from the display form of the image 42B corresponding to the movement route 31B of the transport vehicle 11B. In this manner, by displaying the movement route 31B of the transport vehicle 11B that is highly likely to collide with the user A1 in an emphasized form, the user A1 can avoid collision with the transport vehicle 11B.

In addition, since the image 42A indicating the movement route 31A of the transport vehicle 11A and the image 42B indicating the movement route 31B of the transport vehicle 11B are displayed on the display device 203 of the wearable device 200 so as to be superimposed on the scene, the user A1 can grasp the movement route 31A of the transport vehicle 11A and the movement route 31B of the transport vehicle 11B in real time, and can efficiently avoid the transport vehicle 11A and the transport vehicle 11B, particularly the transport vehicle 11B.

### Sixth Embodiment

The sixth embodiment will be described. Hereinafter, elements denoted by the same reference signs as those in the above-described embodiment have substantially the same configurations and functions as those described in the above-described embodiment unless otherwise specified, and differences from the above-described embodiment will be mainly described.

In a case where there are a plurality of moving bodies in an environment such as a production site, there are a plurality of movement routes corresponding to the plurality of moving bodies, respectively. Hereinafter, a case where the plurality of moving bodies are two transport vehicles will be described as an example. Note that the number of moving bodies is not limited to two.

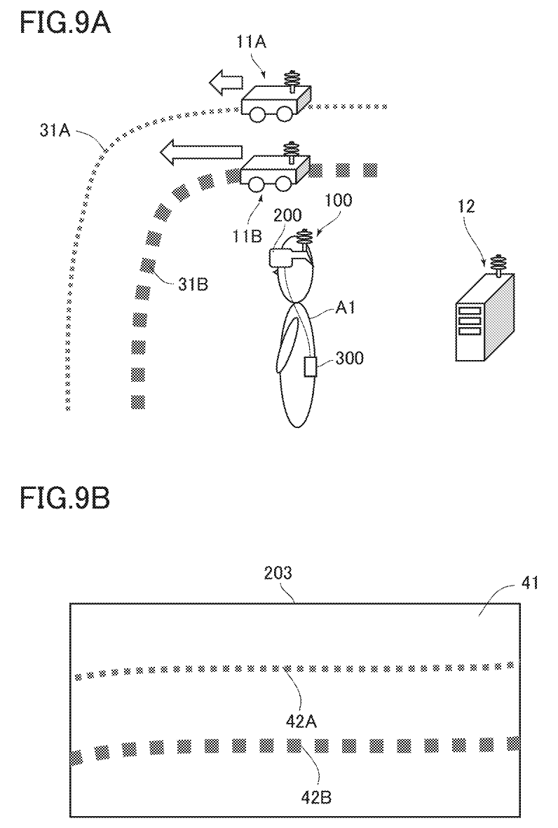

FIG. 9A is an explanatory diagram illustrating an example of an environment in which a wearable device 200 according to the sixth embodiment is used. FIG. 9B is an explanatory diagram illustrating an example of an image notified to a user A1 by the wearable device 200 according to the sixth embodiment.

In the environment such as a production site illustrated in FIG. 9A, there are a movement route 31A corresponding to a transport vehicle 11A moving at a low speed and a movement route 31B corresponding to a transport vehicle 11B moving at a high speed. In addition, in the environment such as a production site, there is a user A1 wearing the wearable device 200. Here, it is assumed that the user A1, the transport vehicle 11A, and the transport vehicle 11B are moving in directions indicated by respective arrows. It is assumed that the movement routes 31A and 31B are present in a field of view 41 of the user A1 wearing the wearable device 200.

Each of the transport vehicle 11A and the transport vehicle 11B transmits information on its position and speed to a server 12. The control device 300 causes the server 12 to perform a movement route acquisition process using the information on the position and the direction of the user A1 (the wearable device 200) as arguments. The server 12 calculates movement routes 31A and 31B of the transport vehicles 11A and 11B corresponding to the position and the direction of the user A1 wearing the wearable device 200, and returns notification information related to the movement routes 31A and 31B. The control device 300 causes a display device 203 of the wearable device 200 to display the acquired notification information related to the movement routes 31A and 31B, that is, images 42A and 42B, so as to be superimposed on the scene. Although the case where the server 12 obtains the images 42A and 42B has been described as an example, the control device 300 may obtain the images 42A and 42B.

In this case, the control device 300 changes the display forms of the images 42A and 42B indicating the movement routes 31A and 31B depending on the speeds of the transport vehicles 11A and 11B, and causes the display device 203 to display the images 42A and 42B. In the example of the sixth embodiment, the speed of the transport vehicle 11B is faster than the speed of the transport vehicle 11A. The control device 300 displays, in an emphasized form, the image 42B corresponding to the movement route 31B of the transport vehicle 11B (for example, displays the line in a bold form). In addition, the control device 300 displays, in a de-emphasized form, the image 42A corresponding to the movement route 31A of the transport vehicle 11A (for example, displays the line in a thin form). That is, the control device 300 causes the display device 203 to display the images 42A and 42B in such a manner that the display form of the image 42A corresponding to the movement route 31A of the transport vehicle 11A is different from the display form of the image 42B corresponding to the movement route 31B of the transport vehicle 11B. In this manner, by displaying the movement route 31B of the transport vehicle 11B that is highly likely to collide with the user A1 in an emphasized form, the user A1 can efficiently avoid collision with the transport vehicle 11B.

In addition, since the image 42A indicating the movement route 31A of the transport vehicle 11A and the image 42B indicating the movement route 31B of the transport vehicle 11B are displayed on the display device 203 of the wearable device 200 so as to be superimposed on the scene, the user A1 can grasp the movement route 31A of the transport vehicle 11A and the movement route 31B of the transport vehicle 11B in real time, and can efficiently avoid the transport vehicle 11A and the transport vehicle 11B, particularly the transport vehicle 11B.

### Seventh Embodiment

The seventh embodiment will be described. Hereinafter, elements denoted by the same reference signs as those in the above-described embodiment have substantially the same configurations and functions as those described in the above-described embodiment unless otherwise specified, and differences from the above-described embodiment will be mainly described.

In a case where there are a plurality of moving bodies in an environment such as a production site, there are a plurality of movement routes corresponding to the plurality of moving bodies, respectively. Hereinafter, a case where the plurality of moving bodies are two transport vehicles will be described as an example. Note that the number of moving bodies is not limited to two.

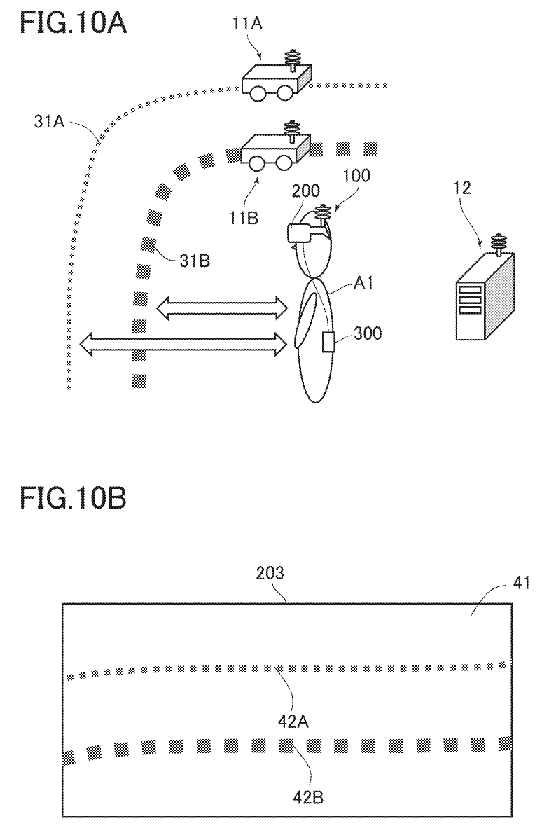

FIG. 10A is an explanatory diagram illustrating an example of an environment in which a wearable device 200 according to the seventh embodiment is used. FIG. 10B is an explanatory diagram illustrating an example of an image notified to a user A1 by the wearable device 200 according to the seventh embodiment.

In the environment such as a production site illustrated in FIG. 10A, there are a movement route 31A corresponding to a transport vehicle 11A and a movement route 31B corresponding to a transport vehicle 11B. In addition, in the environment such as a production site, there is a user A1 wearing the wearable device 200. Here, it is assumed that the user A1 is moving toward the movement routes 31A and 31B. It is assumed that the movement routes 31A and 31B are present in a field of view 41 of the user A1 wearing the wearable device 200.

The control device 300 causes the server 12 to perform a movement route acquisition process using the information on the position and the direction of the user A1 (the wearable device 200) as arguments. The server 12 calculates movement routes 31A and 31B of the transport vehicles 11A and 11B corresponding to the position and the direction of the user A1 wearing the wearable device 200, and returns notification information related to the movement routes 31A and 31B. The control device 300 causes a display device 203 of the wearable device 200 to display the acquired notification information related to the movement routes 31A and 31B, that is, images 42A and 42B, so as to be superimposed on the scene. Although the case where the server 12 obtains the images 42A and 42B has been described as an example, the control device 300 may obtain the images 42A and 42B.

At this time, the control device 300 changes the display forms of the images 42A and 42B indicating the movement routes 31A and 31B depending on the distances between the movement routes 31A and 31B and the user A1. In the seventh embodiment, the control device 300 displays, in an emphasized form, the image 42B corresponding to the movement route 31B relatively close to the user A1 (for example, displays the line in a bold form). In addition, in the fourth embodiment, the control device 300 displays, in a de-emphasized form, the image 42A corresponding to the movement route 31A relatively far from the user A1 (for example, displays the line in a thin form). That is, the control device 300 causes the display device 203 to display the images 42A and 42B in such a manner that the display form of the image 42B corresponding to the movement route 31B relatively close to the user A1 is different from the display form of the image 42A corresponding to the movement route 31A relatively far from the user A1. In this manner, by displaying the movement route 31B of the transport vehicle 11B that is highly likely to collide with the user A1 in an emphasized form, the user A1 can efficiently avoid collision with the transport vehicle 11B.

In addition, the control device 300 may calculate times (arrival times) required for the user A1 to arrive at the movement routes 31A and 31B from the moving speed of the wearable device 200, and change the display forms of the images 42A and 42B indicating the movement routes 31A and 31B depending on the arrival times. In the seventh embodiment, the control device 300 displays, in an emphasized form, the display form of the image 42B corresponding to the movement route 31B having a relatively short arrival time (for example, displays the line in a bold form). In addition, in the fourth embodiment, the control device 300 displays, in a de-emphasized form, the image 42A corresponding to the movement route 31A having a relatively long arrival time (for example, displays the line in a thin form). That is, the control device 300 causes the display device 203 to display the images 42A and 42B in such a manner that the display form of the image 42B corresponding to the movement route 31B having a relatively short arrival time is different from the display form of the image 42A corresponding to the movement route 31A having a relatively long arrival time. In this manner, by displaying the movement route 31B of the transport vehicle 11B that is highly likely to collide with the user A1 in an emphasized form, the user A1 can efficiently avoid collision with the transport vehicle 11B.

### Eighth Embodiment

The eighth embodiment will be described. Hereinafter, elements denoted by the same reference signs as those in the above-described embodiment have substantially the same configurations and functions as those described in the above-described embodiment unless otherwise specified, and differences from the above-described embodiment will be mainly described.

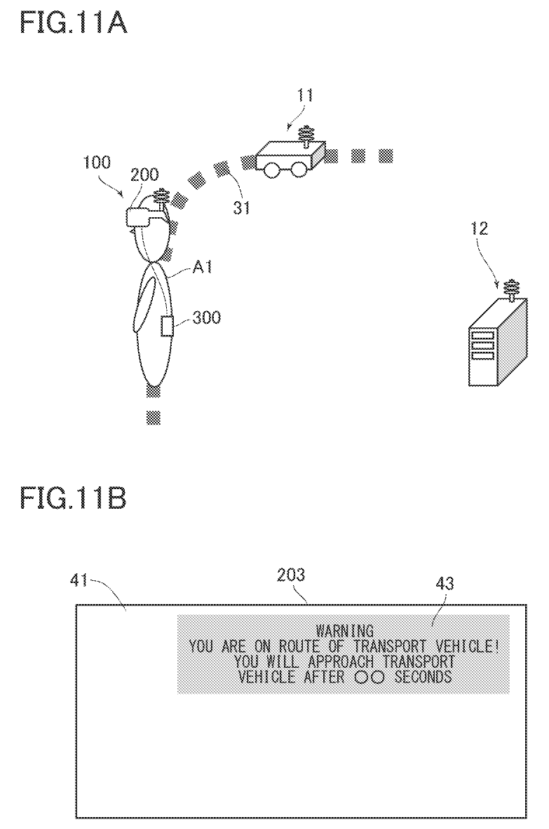

FIG. 11A is an explanatory diagram illustrating an example of an environment in which a wearable device 200 according to the eighth embodiment is used. FIG. 11B is an explanatory diagram illustrating an example of an image notified to a user A1 by the wearable device 200 according to the eighth embodiment.

In the environment such as a production site illustrated in FIG. 11A, there is a movement route 31 corresponding to a transport vehicle 11. In addition, in the environment such as a production site, there is a user A1 wearing the wearable device 200. Here, it is assumed that the user A1 is located on the movement route 31.

A control device 300 causes a server 12 to perform a warning information acquisition process using the information on the position of the user A1 (the wearable device 200) as an argument. The server 12 calculates whether the user A1 is located on the movement route 31 of the transport vehicle 11 based on the position of the user A1 wearing the wearable device 200, and returns warning information (an image 43 indicating a warning) and notification information related to the movement route 31 when the user A1 is located on the movement route 31. The control device 300 causes a display device 203 of the wearable device 200 to display the image 43 indicating the warning. As described above, when the user A1 is located on the movement route 31 of the transport vehicle 11, the control device 300 causes the wearable device 200 to notify that the user A1 is located on the movement route 31 of the transport vehicle 11.

In addition, the control device 300 causes the display device 203 of the wearable device 200 to display an image indicating the movement route 31 in a field of view 41 of the user A1 so as to be superimposed on the scene. In the example of FIG. 11B, since the movement route 31 is not in the field of view 41, an image indicating the movement route 31 is not displayed on the display device 203.

The warning content displayed on the display device 203 may include information on an arrival time required for the transport vehicle 11 to arrive at the user A1 located on the movement route 31. In addition, the warning content displayed on the display device 203 may include a position, a moving direction, a speed, or the like of the transport vehicle 11.

As described above, according to the eighth embodiment, the user A1 can sense that there is a risk of collision with the transport vehicle 11 through the image 43, which is warning information, and can efficiently avoid collision with the transport vehicle 11 by moving away from the movement route 31. Although the case where the image 43 (display content) is calculated by the server 12 has been described as an example, the image 43 may be calculated by the control device 300.

### Ninth Embodiment

The ninth embodiment will be described. Hereinafter, elements denoted by the same reference signs as those in the above-described embodiment have substantially the same configurations and functions as those described in the above-described embodiment unless otherwise specified, and differences from the above-described embodiment will be mainly described.

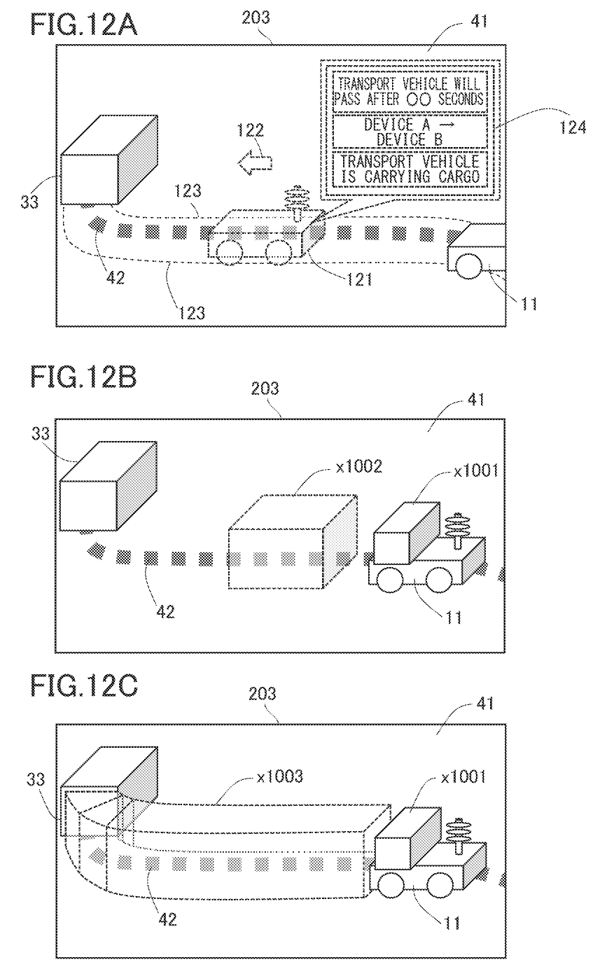

FIG. 12A is an explanatory diagram illustrating an example of an image notified to a user by a wearable device according to the ninth embodiment.

It is assumed that a transport vehicle 11 and a device B 33 existing in an environment such as a production site are in a field of view 41 of a user wearing a wearable device. The control device 300 displays an image 42 indicating a movement route of the transport vehicle 11 so as to be superimposed on a scene.

In addition, in the ninth embodiment, the control device 300 causes a display device 203 to display an image 121 of a model indicating an outer shape of the transport vehicle 11. The image 121 of the model is displayed on the display device 203 so as to be located on the movement route of the transport vehicle 11 and in the line-of-sight direction of the user. As a result, the user can efficiently avoid collision with the transport vehicle 11.

In addition, in the ninth embodiment, the control device 300 causes the display device 203 to display the image 122 indicating the movement direction of the transport vehicle 11. As a result, the user can efficiently avoid collision with the transport vehicle 11.

In addition, in the ninth embodiment, the control device 300 causes the display device 203 to display an image 123 of a predetermined region along the movement route of the transport vehicle 11. As a result, the user can efficiently avoid collision with the transport vehicle 11.

Furthermore, the control device 300 can cause the display device 203 to display an image 124 indicating attribute information such as information on whether the transport vehicle 11 is carrying a cargo, information indicating when the transport vehicle 11 will pass, and information indicating what kind of moving body the transport vehicle 11 is.

FIG. 12B is an explanatory diagram illustrating an example of an image notified to a user by a wearable device according to the first modification of the ninth embodiment. As illustrated in FIG. 12B, the transport vehicle 11 may carry a cargo x1001. In such a case, it is also necessary to consider the size of the cargo x1001.

The control device 300 causes the display device 203 to display an image x1002 of a model including at least the transport vehicle 11, and in the first modification, a model including the transport vehicle 11 and the cargo x1001, so as to be superimposed on the image 42 indicating the movement route. As a result, the user can efficiently avoid collision with the transport vehicle 11.

When the transport vehicle 11 does not load the cargo x1001, the control device 300 may cause the display device 203 to display, for example, an image of a model of the transport vehicle 11, as the model including the transport vehicle 11, so as to be superimposed on the image 42 indicating the movement route.

FIG. 12C is an explanatory diagram illustrating an example of an image notified to a user by a wearable device according to the second modification of the ninth embodiment. As illustrated in FIG. 12C, the transport vehicle 11 may carry a cargo x1001. In such a case, it is also necessary to consider the size of the cargo x1001.

The control device 300 causes the display device 203 to display an image x1003 obtained by sweeping a model including at least the transport vehicle 11, and in the second modification, a model including the transport vehicle 11 and the cargo x1001 along the movement route of the transport vehicle 11 so as to be superimposed on the image 42 indicating the movement route. As a result, the user can efficiently avoid collision with the transport vehicle 11.

When the transport vehicle 11 does not load the cargo x1001, the control device 300 may cause the display device 203 to display, for example, an image obtained by sweeping a model of the transport vehicle 11 along the movement route of the transport vehicle 11, as the model including the transport vehicle 11, so as to be superimposed on the image 42 indicating the movement route.

In the first modification and the second modification as well, as illustrated in FIG. 12A, the control device 300 may cause the display device 203 to display the image 121 of the model of the transport vehicle 11, the image 122 indicating the movement direction, the image 123 of the predetermined region along the movement route of the transport vehicle 11, or the image 124 indicating the attribute information. In addition, the images x1002 and x1003 may be calculated by the server 12 or may be calculated by the control device 300.

### Tenth Embodiment

The tenth embodiment will be described. Hereinafter, elements denoted by the same reference signs as those in the above-described embodiment have substantially the same configurations and functions as those described in the above-described embodiment unless otherwise specified, and differences from the above-described embodiment will be mainly described.

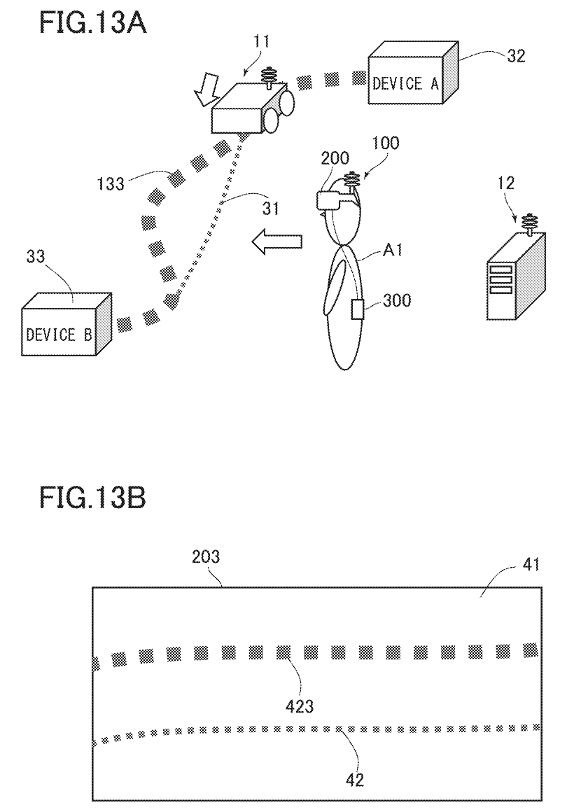

FIG. 13A is an explanatory diagram illustrating an example of an environment in which a wearable device 200 according to the tenth embodiment is used. FIG. 13B is an explanatory diagram illustrating an example of an image notified to a user A1 by the wearable device 200 according to the tenth embodiment.

In the environment such as a production site illustrated in FIG. 13A, there is a movement route 31 corresponding to a transport vehicle 11. In addition, in the environment such as a production site, there is a user A1 wearing the wearable device 200.

In FIG. 13A, an example is illustrated in which, when the user A1 wearing the wearable device 200 approaches the movement route 31 of the transport vehicle 11, the movement route of the transport vehicle 11 is changed from the movement route 31 to a movement route 133. It is assumed that the transport vehicle 11 is moving from a device A 32 toward a device B 33, and the transport vehicle 11 and the user A1 are moving in directions indicated by respective arrows. It is assumed that there is a movement route 133 in a field of view 41 of the user A1 wearing the wearable device 200.

A control device 300 causes a server 12 to perform a warning information acquisition process using the information on the position, the movement direction, and the speed of the user A1 (the wearable device 200) as arguments. The server 12 calculates a likelihood of contact between the user A1 and the transport vehicle 11 from the relationship between the information on the movement route 31 of the transport vehicle 11 and the information on the user A1, and if necessary, recalculates a movement route of the transport vehicle 11 and changes the movement route from the movement route 31 to the movement route 133. Then, the server 12 returns warning information, notification information related to the movement route 31 corresponding to the warning information before the change, and notification information related to the movement route 133 after the change.

The control device 300 causes the display device 203 to display the acquired warning information, and also causes the display device 203 to display the notification information related to the movement route, that is, the image 42 indicating the movement route 31 before the change and the image 423 indicating the movement route 133 after the change so as to be superimposed on the scene. In this manner, when the movement route of the transport vehicle 11 is changed, the control device 300 causes the display device 203 to display the images 42 and 423 indicating the movement routes 31 and 133 before and after the change as the image indicating the movement route.

As a result, when there is a risk of contact between the user A1 and the transport vehicle 11 due to the user A1’s own action, the user A1 can recognize the warning display and the change of the movement route of the transport vehicle 11 from the movement route 31 to the movement route 133. By recognizing this information, the user A1 can efficiently avoid collision with the transport vehicle 11. Note that, although the case where the display content is calculated by the server 12 has been described as an example, the display content may be calculated by the control device 300.

As described above, according to the tenth embodiment, the user A1 can grasp in real time that the movement route of the transport vehicle 11 has been changed from the movement route 31 to the movement route 133, and can efficiently avoid the transport vehicle 11.

### Eleventh Embodiment

The eleventh embodiment will be described. Hereinafter, elements denoted by the same reference signs as those in the above-described embodiment have substantially the same configurations and functions as those described in the above-described embodiment unless otherwise specified, and differences from the above-described embodiment will be mainly described.

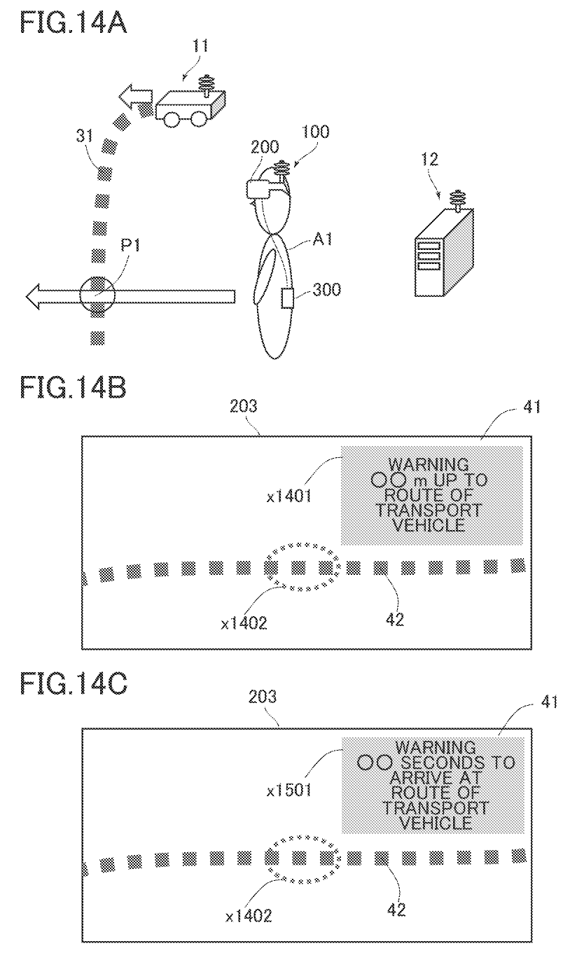

FIG. 14A is an explanatory diagram illustrating an example of an environment in which a wearable device 200 according to the eleventh embodiment is used. FIG. 14B is an explanatory diagram illustrating an example of an image notified to a user A1 by the wearable device 200 according to the eleventh embodiment. FIG. 14C is an explanatory diagram illustrating another example of an image notified to the user A1 by the wearable device 200 according to the eleventh embodiment.

In the environment such as a production site illustrated in FIG. 14A, there is a movement route 31 corresponding to a transport vehicle 11. In addition, in the environment such as a production site, there is a user A1 wearing the wearable device 200. Here, it is assumed that the transport vehicle 11 and the user wearing the wearable device 200 are moving in directions indicated by respective arrows.

The transport vehicle 11 transmits information on its position and speed to a server 12. A control device 300 causes the server 12 to perform a warning information acquisition process using the information on the position, the movement direction, and the speed of the user A1 (the wearable device 200) as arguments.

The server 12 calculates a position P1 at which the movement route 31 of the transport vehicle 11 intersects with a movement path of the user from the information on the position and the movement direction of the user A1 (the wearable device 200). Next, the server 12 calculates a distance between the position of the user A1 and the position P1 of the movement route 31. In response to the warning information acquisition process, when the calculated distance is shorter than a predetermined distance, the server 12 returns information on the distance.

As illustrated in FIG. 14B, the control device 300 causes the display device 203 to display an image x1401, which is information on a distance until the user A1 arrives at the position P1 of the movement route 31, as warning information. At this time, the control device 300 may cause the display device 203 to display an image x1402 indicating the position P1. Through the above processing, the user A1 can grasp the movement route 31 of the transport vehicle 11 in real time and efficiently avoid the transport vehicle 11.

Similarly, the server 12 calculates a time required for the user A1 to arrive at the position P1 of the movement route 31 from the information on the position, the movement direction, and the speed of the user A1 (the wearable device 200), and returns the information on the time in response to the warning information acquisition process of the wearable device 200.

As illustrated in FIG. 14C, the control device 300 causes the display device 203 to display an image x1501, which is information on the time required for the user A1 to arrive at the position P1 of the movement route 31, as warning information. At this time, the control device 300 may cause the display device 203 to display an image x1402 indicating the position P1. Through the above processing, the user A1 can grasp the movement route 31 of the transport vehicle 11 in real time and efficiently avoid the transport vehicle 11.

### Other Modifications

In the above-described embodiment, the case where the notification information related to the movement route of the transport vehicle is visual information by the display device 203 has been described, but the notification information is not limited thereto. For example, the notification information related to the movement route of the transport vehicle may be tactile information by the vibration device 204 or auditory information by the sound device 205. For example, as illustrated in FIG. 8A, in a case where the user A1 is moving toward the position P2 of the movement route 31B, when the difference between the time when the user A1 is scheduled to arrive at the position P2 and the time when the transport vehicle 11B is scheduled to arrive at the position P2 is smaller than a predetermined time, the control device 300 may emit a sound such as “there is a risk of contact with the transport vehicle after ○○ seconds” from the sound device 205. Alternatively, the control device 300 may increase the vibration of the vibration device 204 as the user A1 approaches the position P2.

In addition, the control device 300 may cause the wearable device 200 to notify whether the transport vehicle 11 enters a standby state after arriving at the destination.

The present disclosure is not limited to the embodiments described above, and many modifications can be made within the technical spirit. In addition, the effects described in the present embodiment merely list the most preferable effects resulting from the embodiments of the present disclosure, and are not limited to those described in the present embodiment. In addition, at least two of the plurality of embodiments and the plurality of modifications described above may be combined.

As described above, according to the present disclosure, a technology advantageous for improving productivity is provided.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-067011, filed Apr. 15, 2025, which is hereby incorporated by reference herein in its entirety.

What is claimed is:

1. A system comprising:
a wearable device configured to notify information to a user of the wearable device; and
a control device,
wherein the control device is configured to cause the wearable device to notify notification information related to a movement route of a moving body.

2. The system according to claim 1, wherein
the control device is configured to:
acquire information on a position and a direction of the user;
receive information on the movement route from a server; and
obtain the notification information by using the information on the movement route and the information on the position and the direction of the user.

3. The system according to claim 1, wherein
the control device is configured to:
acquire information on a position and a direction of the user; and
transmit the information of the position and the direction of the user to a server, and request the server for the notification information.

4. The system according to claim 2, wherein
the control device is configured to acquire information on a movement route in a field of view of the user, as the information on the movement route, from the server.

5. The system according to claim 1, wherein
the notification information is an image indicating the movement route.

6. The system according to claim 5, wherein
the movement route includes a first route along which the moving body has not moved, and a second route along which the moving body has moved, and
the control device is configured to cause the wearable device to notify the image indicating the movement route in such a manner that the image indicating the first route is displayed in a different form from the image indicating the second route in the image indicating the movement route.

7. The system according to claim 5, wherein
the movement route includes a first route along which the moving body has not moved, and a second route along which the moving body has moved, and
the control device is configured to cause the wearable device to notify only an image indicating the first route as the image indicating the movement route.

8. The system according to claim 5, wherein
the control device is configured to cause the wearable device to notify the image indicating the movement route so as to be superimposed on a scene viewed from the user or a scene image obtained by imaging the scene.

9. The system according to claim 5, wherein
the control device is configured to change a display form of the image indicating the movement route depending on whether the moving body is approaching or moving away from the user.

10. The system according to claim 5, wherein
the control device is configured to, in a case where the movement route intersects with a movement path of the user, change a display form of the image indicating the movement route depending on a time required for the moving body to pass through an intersecting position.

11. The system according to claim 5, wherein
the control device is configured to change a display form of the image indicating the movement route depending on a distance between the moving body and the user, a speed of the moving body, a distance between the movement route and the user, or a time required for the user to arrive at the movement route.

12. The system according to claim 1, wherein
the control device is configured to, in a case where the user is located on the movement route of the moving body, cause the wearable device to notify that the user is located on the movement route of the moving body.

13. The system according to claim 12, wherein
the control device is configured to cause the wearable device to notify a time required for the moving body to arrive at the user located on the movement route.

14. The system according to claim 5, wherein
the control device is configured to cause the wearable device to notify an image of a model of the moving body, an image indicating a movement direction of the moving body, or an image of a predetermined region along the movement route.

15. The system according to claim 5, wherein
the control device is configured to cause the wearable device to notify an image of a model including the moving body or an image obtained by sweeping the model along the movement route so as to be superimposed on the image indicating the movement route.

16. The system according to claim 5, wherein
the control device is configured to, in a case where the movement route is changed, cause the wearable device to notify images indicating movement routes before and after the change as the image indicating the movement route.

17. The system according to claim 1, wherein
the control device is configured to cause the wearable device to notify information on a distance until the user arrives at the movement route or information on a time required for the user to arrive at the movement route.

18. A control method for controlling a wearable device configured to notify information to a user of the wearable device, the control method comprising:
causing the wearable device to notify notification information related to a movement route of a moving body.

19. A method for manufacturing an article using a moving body, the method comprises acquiring information related to a movement route of the moving body by the control method according to claim 18.

20. A non-transitory computer-readable recording medium recording a program for causing a computer to execute the control method according to claim 18.
